(19) United States
(12) Patent Application Publication
(10) Pub. No.: US 2007/0006130 A1
(43) Pub. Date: Jan. 4, 2007

(54) Model oriented method of automatically detecting alterations in the design of a software system

(76) Inventors: Arnold Stamler, Palo Alto, CA (US); Tohru Kao, San Jose, CA (US)

Correspondence Address: WAGNER, MURABITO & HAO LLP;Third Floor, Two North Market Street, San Jose, CA, 95113, US

(21) Appl. No.: 11/144,177

(22) Filed: Jun. 2, 2005

(51) Int. Cl. G06F 9/44

(52) U.S. Cl. 717/104; 717/120

(57) ABSTRACT

A method of detecting alterations in the design of a software system over the development and maintenance life cycle of the software system is disclosed. A baseline model of the software system is generated. A current model of the software system is also generated. The current model is automatically compared with the baseline model, and any alteration in the design of the software system is identified.

### BACKGROUND

1. Field of the Invention

The present invention relates to the development of software systems, and more particularly to tracking changes in the overall design of such software systems.

2. Related Art

Major software development projects begin with a clear and specific design in mind. In the early stages of development, each major component of a software system and its interaction with the other components of the system is specified, often before any code is written. Several reasons exist to have such a high-level design schematic in place for a complicated software system: different teams of programmers will likely work on different sections, making it crucial to have a predetermined method for their processes of the overall system to interact; the designers of the system can quickly reference the design if new features need to be added, without having to stumble through thousands of lines of code; and those responsible for maintaining and further developing the system will have an easy reference to work with, when implementing changes. A number of tools exist for codifying system design; among them are representational languages, such as uniform modeling language (UML), which produce a model of a system that is easy to understand and follow.

Unfortunately, common practices within the software development community do not allow much time for reference to the design model. When a defect is located, the engineer assigned to fix it will rarely have access to the design model, or time to reference it. A number of issues result from this approach. First, a “quick fix” to an existing problem, made without consideration of the overall system design, will often result in a new problem, or several new problems. Second, each change goes undocumented in the overall system design; sufficient changes result in a system that no longer corresponds to the written specifications. Further, any attempt to reconcile the design specification and the system is likely to fail, given the complexities introduced by quick fixes and poorly considered design changes. Finally, the system architects have no means for seeing the current status of their system, relative to the initial system design, and so cannot catch problems at the design level.

Over a number of system iterations, more and more defects will be identified and fixed, while unintentionally introducing new defects or side effects. With enough such impromptu software patches or fixes, the initial system design is altered to such a degree that the software becomes unmanageable.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be implemented.

FIG. 2 is a process diagram of a method for detecting alterations in the design of a software system over the development and maintenance life cycle of the software system is depicted, in accordance with one embodiment of the invention.

FIG. 3 is a process diagram of the Define phase, in accordance with one embodiment of the present invention.

FIG. 4 is a process diagram of the Validate phase, in accordance with one embodiment of the present invention.

FIG. 5 is a process diagram of the Update phase, in accordance with one embodiment of the present invention.

FIG. 6 is an exemplary UML model of a software system, in accordance with one embodiment of the present invention.

FIG. 7 is an exemplary UML model of a software system, in accordance with one embodiment of the present invention.

FIG. 8 is a flowchart of a method for detecting alterations in the design of a software system over the development and maintenance life cycle of the software system is depicted, in accordance with one embodiment of the invention.

### DETAILED DESCRIPTION

A method of detecting alterations in the design of a software system over the development and maintenance life cycle of the software system, and a system implementing this method, are disclosed. The method calls for generating a baseline model of the software system. The method also calls for generating a current model of the software system, which is reverse engineered from the code base. The method calls for the automatic comparison of the current model with the baseline model to identify an alteration in the design of the software system. The comparison occurs according to the criteria and policies which are pre-defined in terms of the high level design language constructs (e.g. UML sequence diagrams, class and object definitions, collaboration diagrams. etc.) The result of this policy evaluation can result in the auto-notification to responsible parties or other actions. Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

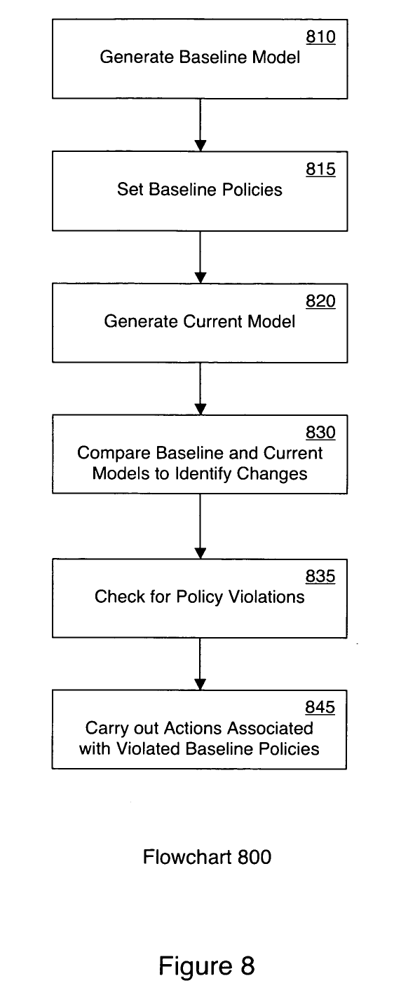

Portions of the detailed description that follows are presented and discussed in terms of a method. Although steps and sequencing thereof are disclosed in a figure herein (e.g., FIG. 8) describing the operations of this method, such steps and sequencing are exemplary. Embodiments of the present invention are well suited to performing various other steps or variations of the steps recited in the flowchart of the figure herein, and in a sequence other than that depicted and described herein.

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “writing,” “including,” “testing,” “using,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

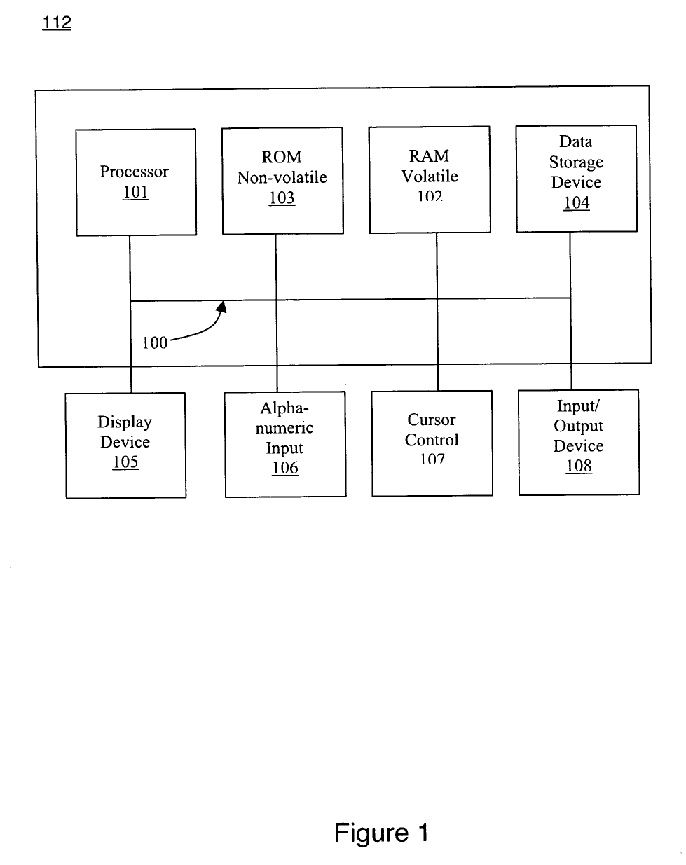

Referring now to FIG. 1, a block diagram of an exemplary computer system 112 is shown. It is appreciated that computer system 112 described herein illustrates an exemplary configuration of an operational platform upon which embodiments of the present invention can be implemented. Nevertheless, other computer systems with differing configurations can also be used in place of computer system 112 within the scope of the present invention. That is, computer system 112 can include elements other than those described in conjunction with FIG. 1. Moreover, the present invention may be practiced on any system which can be configured to allow it, not just computer systems like computer system 112.

Computer system 112 includes an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, etc.) coupled with bus 100 for storing static information and instructions for processor 101. Computer system 112 may also contain an optional display device 105 coupled to bus 100 for displaying information to the computer user. Moreover, computer system 112 also includes a data storage device 104 (e.g., disk drive) for storing information and instructions.

Also included in computer system 112 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface (input/output device) 108, which is also coupled to bus 100, and can be a serial port. Communication interface 108 may also include wireless communication mechanisms. Using communication interface 108, computer system 112 can be communicatively coupled to other computer systems over a communication network such as the Internet or an intranet (e.g., a local area network).

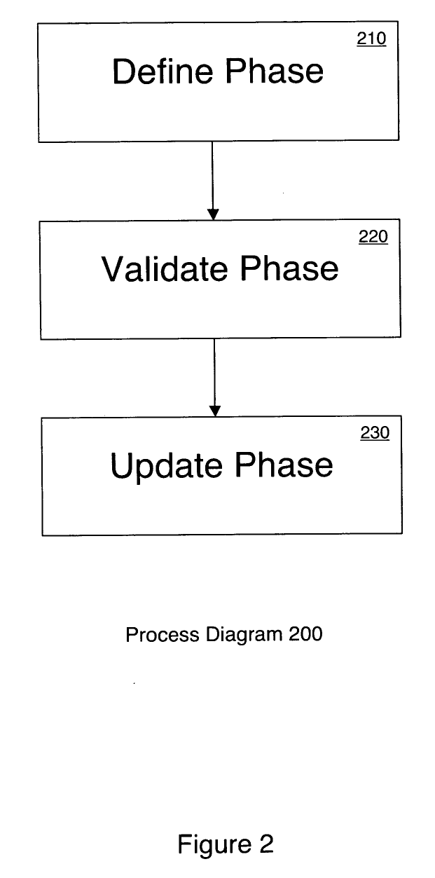

With reference now to FIG. 2, a process diagram 200 of a method for detecting alterations in the design of a software system over the development and maintenance life cycle of the software system is depicted, in accordance with one embodiment of the invention. Although specific steps are disclosed in process diagram 200, such steps are exemplary. That is, embodiments of the present invention are well suited to performing various other (additional) steps or variations of the steps recited in process diagram 200. It is appreciated that the steps in process diagram 200 may be performed in an order different than presented, and that not all of the steps in process diagram 200 may be performed.

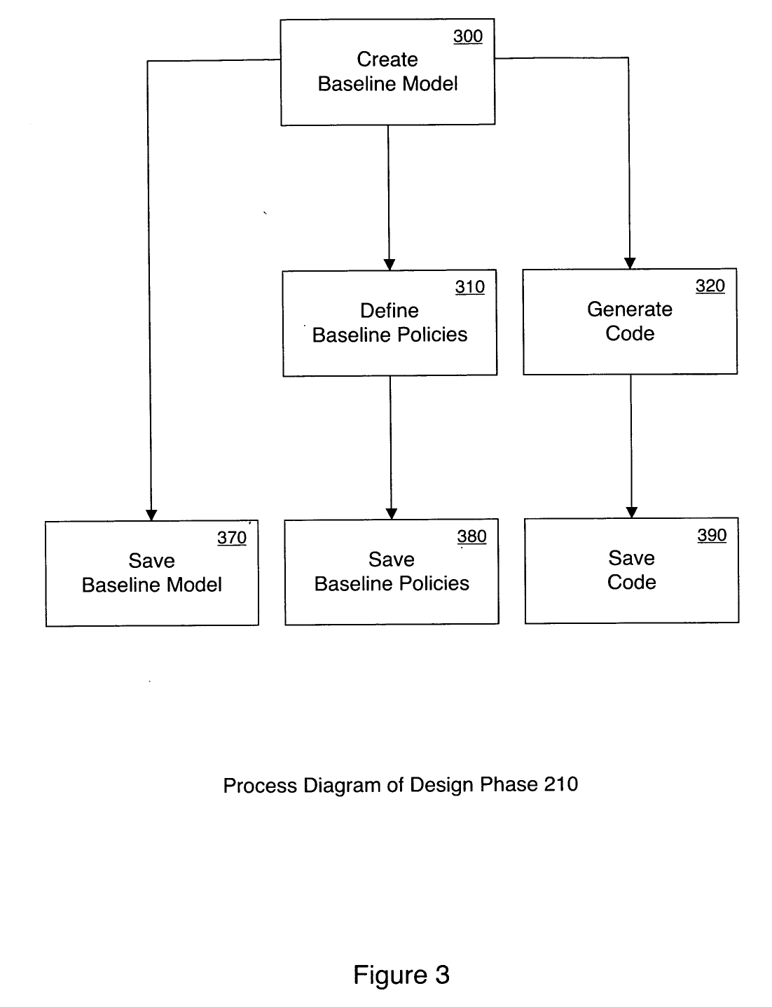

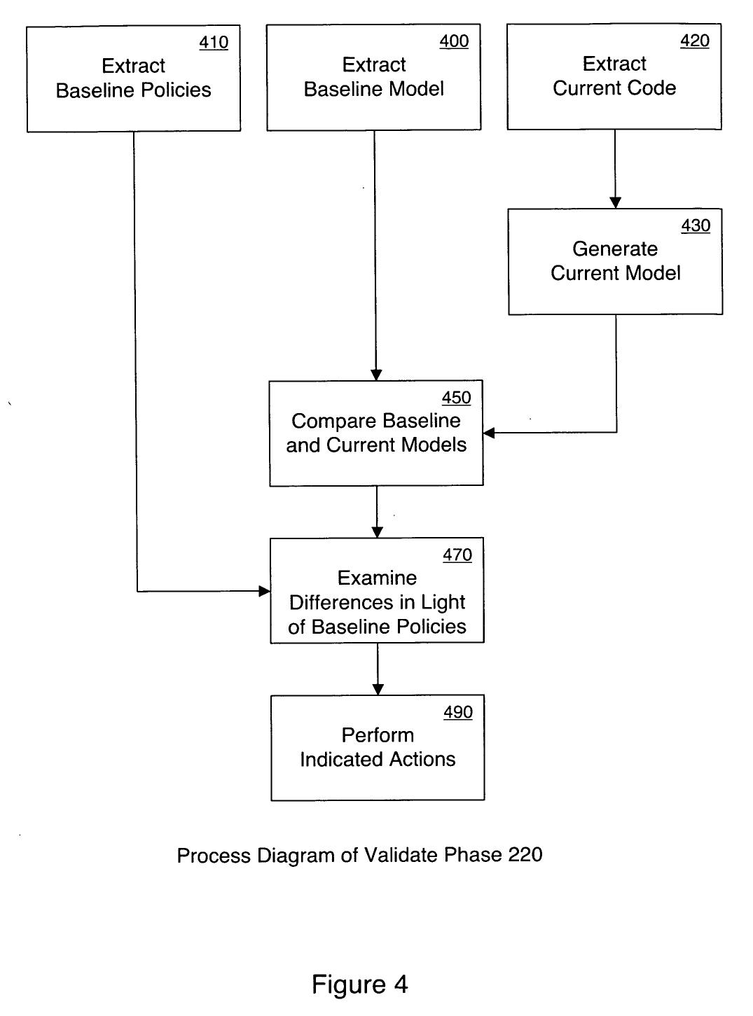

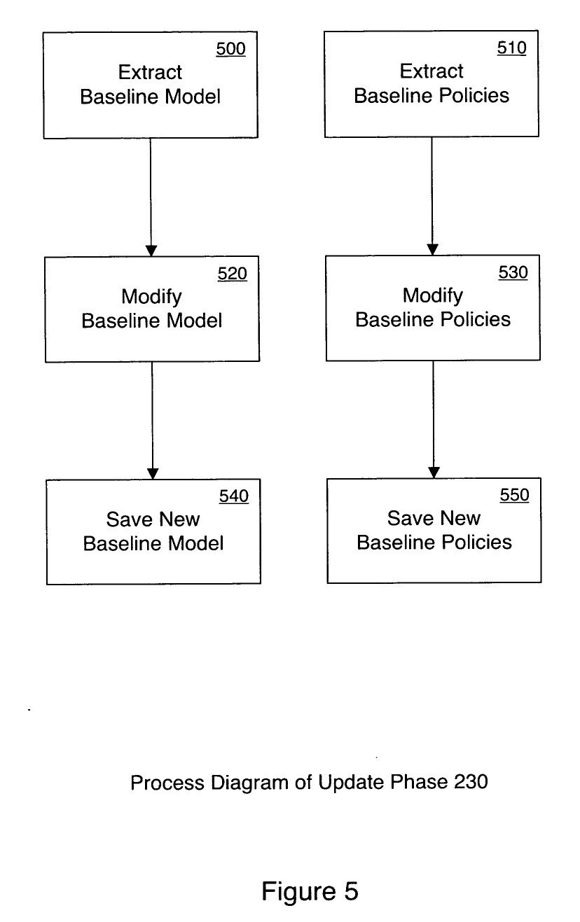

Process diagram 200 presents the method in three phases, in accordance with one embodiment of the invention: Define phase 210; Validate phase 220; and Update phase 230. During Define phase 210, a user of the present invention establishes a baseline model for the system being tracked. This phase is explained in greater depth with reference to FIG. 3, below. During Validate phase 220, a model of the system as it currently exists is compared with the baseline model established during Define phase 210. This phase is explained in greater depth with reference to FIG. 4, below. During Update phase 230, the user may modify the initial policies set in place with the baseline model during Define phase 210, or update the baseline model itself to allow for new design constraints or policies. This phase is explained in greater depth with reference to FIG. 5, below.

With reference now to FIG. 3, a process diagram of Define phase 210 is depicted, in accordance with one embodiment of the present invention. Define phase 210, in this embodiment, comprises a number of processes related to the identification of alterations in the design of a software system over time. Although specific processes are disclosed in this diagram, such processes are exemplary. That is, embodiments of the present invention are well suited to combination with various other (additional) processes or variations of the processes recited in the block diagram of Define phase 210. It is appreciated that the processes disclosed may be executed in an order different than presented, and that not all of the processes may be executed.

In process 300, the initial baseline model is created. In one embodiment, this baseline model is the result of traditional software design practices. In another embodiment, where code has already been written, the initial baseline model might be extracted from existing code. One embodiment call for the baseline model to be created in a representational language, such as UML. Other embodiments use functional decomposition models based on Yourdon structure, while others use data flow diagrams, structure charts, or entity life history, or any other way that allows for the relationships between elements of the software system to be understood.

The baseline model generated in process 300 is used in three different ways, in this embodiment. First, the baseline model is stored for later comparison to later versions of the software system. In embodiments where the baseline model is generated in a computer-readable format, or may be translated into such a format, process 370 takes the baseline model and stores it. In one embodiment, the baseline model is stored in the same software repository as will be used to store the code for the software system. In other embodiments, the model may be stored separately.

Second, the baseline model is used to define policies for the software system. In one embodiment, process 310 allows the user to specify which portions of the baseline model should be monitored for changes throughout the life cycle of the software system. In one embodiment, such policies specify which elements of a design are allowed to change, and which are not. Exemplary elements include the associations between classes, defined functions, or public variable types. In another embodiment, a policy can also be set to define whether a class is allowed to be extended or not, and where an extended class is allowed to be contained.

In another embodiment, process 310 also allows a user to specify an action to take if a new version of the software system is found to violate one of these policies. Exemplary actions include notification actions, such as sending an electronic message to a designated person responsible for overseeing compliance with that policy, and also more forceful actions, such as preventing noncompliant code from entering a stable build of a software system until it is corrected, or until an authorized user overrides the objection. A further embodiment allows a user to specify a level of priority or importance to assign to each policy, to aid in conflict resolution should a desired change affect multiple policies.

In one embodiment, once the policies are defined in process 310, process 380 stores these policies. In one embodiment, the policies are stored in the same software repository as will be used to store the code for the software system. In another embodiment, the policies are stored separately.

The third use for the baseline model, in this embodiment, is to allow for the generation of code. The use of a baseline model of a software system to generate code is well known to one of ordinary skill in the art, and can be accomplished in numerous different ways. In one embodiment, where the baseline model is structured in accordance with UML, the individual classes can be assigned to different teams of programmers to generate the code to implement each class. Other embodiments use other methods to generate the system code from the baseline model.

In one embodiment, once the code is generated in process 320, process 390 calls for the code to be stored. In one embodiment, the code is stored in a software repository, of which many examples are known in the art. In another embodiment, a different method of storing the code is used.

With reference now to FIG. 4, a process diagram of Validate phase 220 is depicted, in accordance with one embodiment of the present invention. Validate phase 220, in this embodiment, consists of a number of processes related to the identification of alterations in the design of a software system over time. Although specific processes are disclosed in this diagram, such processes are exemplary. That is, embodiments of the present invention are well suited to combination with various other (additional) processes or variations of the processes recited in the block diagram of Validate phase 220. It is appreciated that the processes disclosed may be executed in an order different than presented, and that not all of the processes may be executed.

Validate phase 220, in one embodiment, is executed after the code base for the software system has been altered. In one embodiment, the execution of Validate phase 220 is automatic, and can be set to run based on time. In another embodiment, Validate phase 220 can be manually activated. In a further embodiment, every process in Validate phase 220 is automated and requires no user interaction.

Process 400, in one embodiment, extracts a copy of the baseline model from wherever it is stored. As noted above with reference to process 370, the baseline model, in one embodiment, is stored in the same software repository as the code for the software system. In another embodiment, the baseline model is stored separately.

Process 410, in one embodiment, extracts a copy of the baseline policies from wherever they are stored. As noted above with reference to process 380, the baseline policies, in one embodiment, are stored in the same software repository as the code for the software system. In another embodiment, the baseline policies are stored separately.

Process 420, in one embodiment, extracts a copy of the current code base from wherever it is stored. Much as noted above with reference to process 390 and the initial code, the current code, in one embodiment, is stored in a software repository. In another embodiment, the current code is stored separately.

Once the current code has been extracted, process 430 generates a current model of the software system from the code. In one embodiment, an existing tool known in the art, such as BORLAND® Software Corporation's LiveSource™ tool, is used to automatically generate a current model of the software system in UML. Other embodiments can use other tools, and generate current models in accordance with another representational language.

Process 450, in one embodiment, compares the baseline model of the software system with the current model. Because, in one embodiment, both the baseline model and the current model are stored in a computer-readable format, this process can be completely automatic. Process 450 is used to identify any changes in the design of the software system between the baseline model and the current model. In one embodiment, all such changes are stored, to enable a designer to construct a complete log of all changes to system design over the life cycle of a software system.

Process 470, in one embodiment, examines the changes in the design of the software system in light of the baseline policies. In one embodiment, any changes that are in violation of a baseline policy will trigger the associated action.

In another embodiment, process 450 and process 470 are combined, such that only those portions of the system design that have baseline policies associated with them are examined for changes.

Process 490, in one embodiment, performs any actions indicated by process 470, as a result of violations of the baseline policies. As discussed above, with reference to process 310, in one embodiment a violation of a baseline policy would result in an electronic message being sent to a specified system maintainer or programmer. In another embodiment, a violation of a baseline policy would prevent the offending code from being included in the current stable version of the software system.

With reference now to FIG. 5, a process diagram of Update phase 230 is depicted, in accordance with one embodiment of the present invention. Update phase 230, in this embodiment, consists of a number of processes related to the identification of alterations in the design of a software system over time. Although specific processes are disclosed in this diagram, such processes are exemplary. That is, embodiments of the present invention are well suited to combination with various other (additional) processes or variations of the processes recited in the block diagram of Update phase 230. It is appreciated that the processes disclosed may be executed in an order different than presented, and that not all of the processes may be executed.

Update phase 230, in one embodiment, is executed after the code base and the system design for the software system has been altered. In one embodiment, new features have been added to the software system that require new policies to protect them from changes. In another embodiment, a change has been made in the system design that renders the old baseline policies and baseline model obsolete.

Process 500, in one embodiment, extracts a copy of the baseline model from wherever it is stored. As noted above with reference to process 370, the baseline model, in one embodiment, is stored in the same software repository as the code for the software system. In another embodiment, the baseline model is stored separately.

Process 510, in one embodiment, extracts a copy of the baseline policies from wherever they are stored. As noted above with reference to process 380, the baseline policies, in one embodiment, are stored in the same software repository as the code for the software system. In another embodiment, the baseline policies are stored separately.

Process 520, in one embodiment, allows for modification of the baseline policy. Such modification could be accomplished through a variety of means. For example, a new baseline model, extracted from the current code base in a manner similar to that discussed above with reference to process 430, could be substituted for the initial baseline model. Alternatively, an editing tool, such as one used for modifying UML models, could be used to alter the original baseline model. Other embodiments call for other means of modifying the baseline model.

Process 540, in embodiments where the modified baseline model is generated in a computer-readable format, or may be translated into such a format, takes the modified baseline model and stores it. In one embodiment, the modified baseline model is stored in the same software repository as is used to store the code for the software system. In other embodiments, the model may be stored separately.

Process 530, in one embodiment, allows for modification of the baseline policies. In one embodiment, such modifications may be accomplished through the same means as those used to initially set the baseline policies, as discussed above with reference to process 310. In other embodiments, other means for modifying the baseline policies are used.

According to one embodiment, process 550 stores the modified baseline policies, once these policies are defined in process 530. In one embodiment, the modified baseline policies are stored in the same software repository as is used to store the code for the software system. In another embodiment, the policies are stored separately.

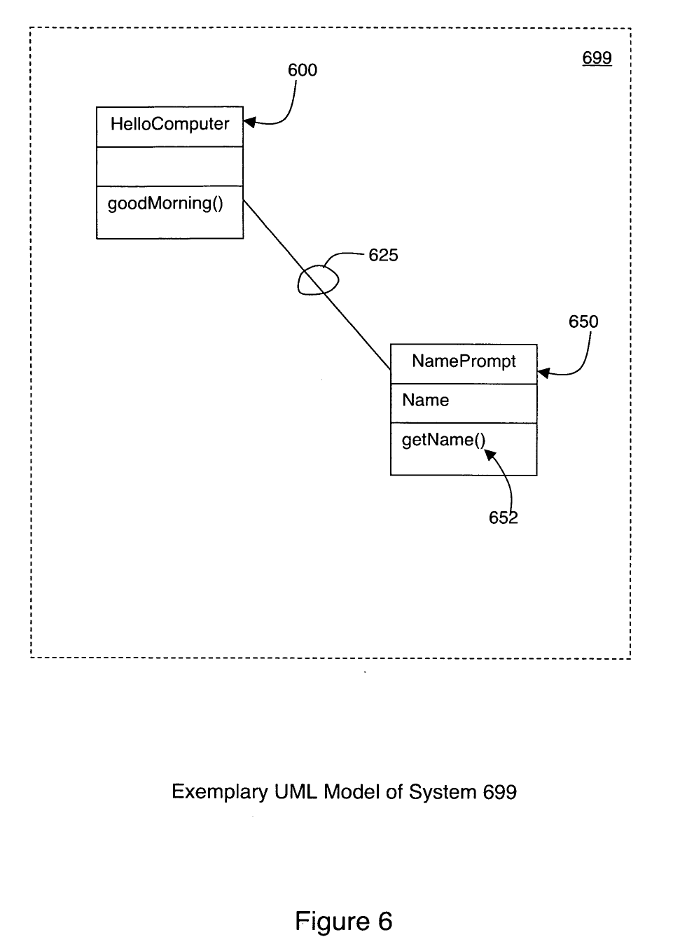

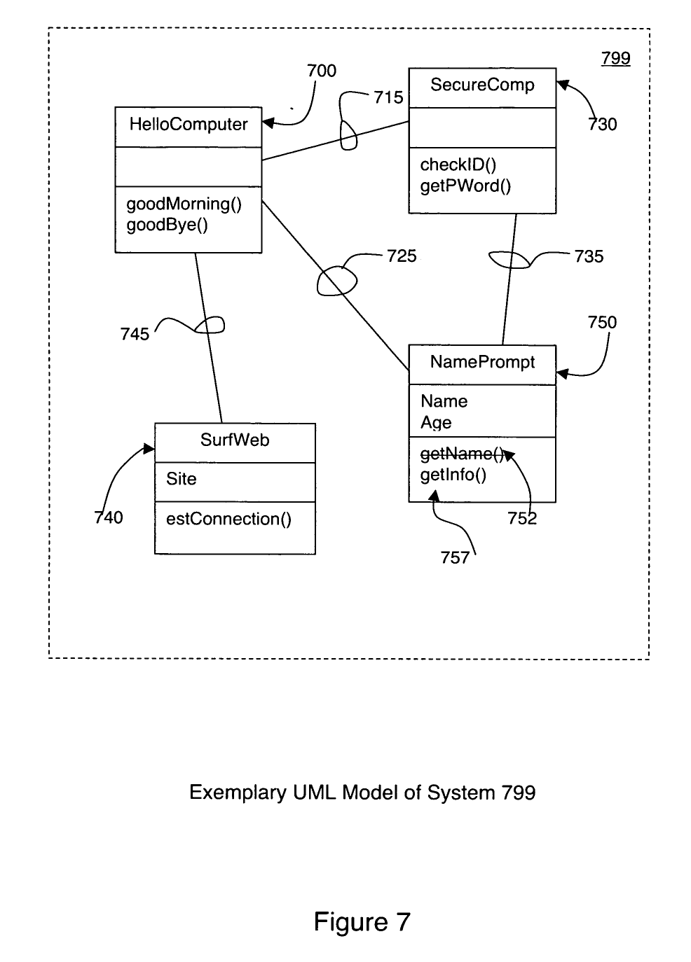

With reference now to FIGS. 6 and 7, exemplary UML models of a software system is depicted, in accordance with one embodiment of the present invention. It is understood that these models illustrative of the above-described embodiments of the present invention only, and are not intended to limit the scope of the present invention in any way.

With reference now to FIG. 6, a UML Model 699 of a simple software system is depicted, in accordance with one embodiment of the present invention. Model 699 includes only two classes, HelloComputer 600 and NamePrompt 650, which are associated with each other, as indicated by Association 625. For exemplary purposes, Model 699 will be considered a baseline model, as discussed above with reference to Define phase 210 and process 300.

In accordance with process 370, a copy of Model 699 is stored in a software repository.

In accordance with process 310, any baseline policies with respect to Model 699 must be set. For this example, two policies are set, as described below in table 1. It is understood that baseline policies can address any element of a system design, not just those selected in this example.

TABLE 1
Baseline Policies

Association 625 must remain intact, else send an
electronic message to the system designer.
Function getName( ) 652 must remain available as part
of class NamePrompt 650, else send an electronic
message to the system designer.

In accordance with process 380, these policies are stored in the same software repository as the copy of Model 699.

In accordance with process 320, code is written to implement the system described by Model 699.

In accordance with process 390, this code is stored in a software repository.

With reference now to FIG. 7, a UML Model 799 of a software system is depicted. Model 799 depicts the same system as Model 699 after several cycles of system development. Model 799 includes four classes: HelloComputer 700, NamePrompt 750, SecureComp 730, and SurfWeb 740, interconnected by a plurality of associations. For exemplary purposes, Model 799 will be considered a current model, as discussed above with reference to Validate phase 220 and process 430.

In accordance with process 400, the baseline model, Model 699, is extracted from the software repository.

In accordance with process 410, the baseline policies are extracted from the software repository (see Table 1).

In accordance with process 420, the current code is extracted from the software repository. From the current code, in accordance with process 430, the current model, Model 799, is generated.

In accordance with process 450, the baseline model and the current model are compared. Model 699 and Model 799 are different in the ways listed below in Table 2:

TABLE 2
Changes in Baseline Model 699

```
Class HelloComputer:
    New operation: goodBye( )
    New Association with class SecureComp
    New Association with class SurfWeb
Class NamePrompt
    New attribute: Age
    New operation: getInfo( )
    Deleted operation: getName( )
New class: SecureComp
    Operations: checkID( ), getPWord( )
New class: SurfWeb
    Attributes: Site
    Operations: estConnection( )
```

In accordance with process 470, once the comparison of models conducted in process 450 is complete, the differences between the two models are examined in light of the baseline policies, as listed in Table 1. As can be seen, one of the two policies has been violated by the current version of the code: getNameo 652 of NamePrompt 650 has been deleted in the version of the system represented by Model 799.

In accordance with process 490 and the action specified in the baseline policies, an electronic message is therefore sent to the system designer, notifying him or her of the violation of the baseline policies for this software system.

Continuing this example, the system designer decides to modify the baseline model and the baseline policies to adopt the new system design reflected by Model 799, and therefore follows the processes laid out with respect to Update phase 230.

In accordance with process 500, the baseline model, Model 699, is extracted from the software repository.

In accordance with process 510, the baseline policies, printed in Table 1, are extracted from the software repository.

In accordance with process 520, the baseline model is replaced with the modified baseline model. Here, the system designer elects to use Model 799, rather than modifying Model 699 to reflect the new changes.

In accordance with process 530, the baseline policies are replaced with the modified baseline policies. The system designer elects to add a new policy, as well as correcting the now-obsolete getName( ) policy, as is illustrated below in Table 3.

TABLE 3
Modified Baseline Policies

Association 725 must remain intact, else send an
electronic message to the system designer.
Function getInfo( ) 757 must remain available as part
of class NamePrompt 750, else send an electronic
message to the system designer.
Association 745 must remain intact, else send an
electronic message to the system designer and the
programmer who wrote the code that broke Association
745.

In accordance with process 540, the modified baseline model, Model 799, is stored in the software repository.

In accordance with process 550, the modified baseline policies, listed in Table 3, are stored in the software repository.

With reference now to FIG. 8, a flowchart 800 of a method of detecting alterations in the design of a software system over the development and maintenance life cycle of the software system is depicted, in accordance with one embodiment of the invention. Although specific steps are disclosed in flowchart 800, such steps are exemplary. That is, embodiments of the present invention are well suited to performing various other (additional) steps or variations of the steps recited in flowchart 800. It is appreciated that the steps in flowchart 800 may be performed in an order different than presented, and that not all of the steps in flowchart 800 may be performed.

In step 810 of flowchart 800, in one embodiment, a baseline model of a software system is generated. As discussed above with reference to Define phase 210 and process 300, such a baseline model can be the result of numerous means. For example, in one embodiment, a baseline model is the result of traditional software engineering practices. In another embodiment, the baseline model is the result of the application of a model-generating tool to an existing code base.

In optional step 815 of flowchart 800, a user sets baseline policies for the software system, based on the baseline model. As discussed above with reference to Define phase 210 and process 310, such baseline policies are used to protect portions of the system design that the user considers important. In another embodiment, the user can also specify an action to be taken if the baseline policy is violated, such as sending a specified person an electronic message.

In step 820 of flowchart 800, in one embodiment, a current model of the software system is generated. As discussed above with reference to Validate phase 220 and process 430, the current model of the system represents the present state of the code base. In one embodiment, the current model is generated automatically from the code base, using tools to create a model in the same format as the baseline model.

In step 830 of flowchart 800, in one embodiment, the current model of the software system is compared with the baseline model. As discussed above with reference to Validate phase 220 and process 450, any differences between the current model and the baseline model are detected in this step. In one embodiment, this comparison is handled automatically by a computer system implementing this invention.

In optional step 835 of flowchart 800, in one embodiment, the differences between the current model of the software system and the baseline model are examined in light of the baseline policies. As discussed above with reference to Validate phase 220 and process 470, the differences between the current model and the baseline model are examined for violations of the baseline policies.

In another embodiment, steps 830 and 835 are combined, such that the only comparisons made between the current model and the baseline model are to check for violations of the baseline policies.

In optional step 845, any actions specified by baseline policies violated by the current model are carried out. As discussed above with reference to Validate phase 220 and process 490, if the baseline policy has an action specified, it is carried out if the current model violates the policy. In one embodiment, violation of a baseline policy results in an electronic message or email being sent to a person responsible for maintaining the code base of the software system.

The embodiments of the present invention described above therefore address many of the problems of system management that exist at present within the art. By comparing the current version of a software system with the original design of the system at a high level, it is more readily apparent where substantive deviations from the initial design have entered the system. Automation of both the generation of a current representation of the system and the comparison process removes many of the otherwise time-consuming barriers; being able to define design rules and specify actions to be taken in case of violation of the design rules allows system designers and maintainers to spend less time worrying about the integrity of the current system, as the present invention would notify them if problems arise.

Embodiments of the present invention described above thus relate a method of detecting alterations in the design of a software system. While the present invention has been described in particular embodiments, it should be appreciated that the present invention should not be construed as limited by such embodiments, but rather construed according to the below claims.

What is claimed is:

1. A method of detecting alterations in a design of a software system over the development and maintenance life cycle of said software system, said method comprising:
generating a baseline model of said software system;
generating a current model of said software system; and
automatically comparing said current model with said baseline model to identify an alteration in said design.

2. The method of claim 1, further comprising:
setting a baseline policy with respect to said baseline model; and
determining if said alteration is a violation of said baseline policy.

3. The method of claim 1, wherein said baseline model and said current model are generated in accordance with the Uniform Modeling Language (UML).

4. The method of claim 2, wherein said setting a baseline policy with respect to said baseline model comprises:
identifying a portion of said baseline model that should not change; and
specifying a notification action to be taken should said baseline policy be violated.

5. The method of claim 4, wherein said setting a baseline policy with respect to said baseline model further comprises:
setting a priority level for a violation of said baseline policy.

6. The method of claim 4, wherein said notification action comprises:
sending an electronic message to a pre-identified person.

7. The method of claim 4, further comprising:
if said alteration is a violation of said baseline policy, performing said notification action.

8. A computer-usable medium having computer-readable program code embodied therein for causing a computer system to execute a method of detecting changes in an initial design of a software system over the development and maintenance life cycle of said software system, said method comprising:
defining important elements of said initial design of said software system; and
validating the current design of said software system by comparing said current design with said important elements of said initial design.

9. The computer-usable medium of claim 8, wherein said defining important elements comprises:
creating a representation of said initial design of said software system; and
identifying portions of said representation of said initial design as important elements.

10. The computer-usable medium of claim 9, further comprising:
specifying an action to be taken if a change is detected in said important elements.

11. The computer-usable medium of claim 8, wherein said validating the current design comprises:
creating a representation of said current design of said software system; and
detecting a change in said important elements by inspecting said representation of said current design in light of said important elements.

12. The computer-usable medium of claim 11, further comprising:
carrying out a specified action if a change in said important elements is detected.

13. The computer-usable medium of claim 11, wherein said creating a representation of said current design of said software system comprises:
creating a representation of said software system from the current code for implementing said software system.

14. The computer-usable medium of claim 13, wherein said representation of said current design is generated in accordance with the Uniform Modeling Language (UML).

15. The computer-usable medium of claim 8, further comprising:
updating said important elements of said initial design with element from said current design.

16. A system for detecting alterations in a design of a software system over the development and maintenance life cycle of said software system, said system comprising:
means for generating a baseline model of said software system;
means for generating a current model of said software system; and
means for comparing said baseline model with said current model, in order to identify an alteration in said design.

17. The system of claim 16, further comprising:
means for establishing a baseline policy with respect to an association within said baseline model.

18. The system of claim 17, further comprising:
means for enforcing said baseline policy.

19. The system of claim 17, wherein said means for establishing a baseline policy further comprises:
means for setting a priority level for violation of said baseline policy.

20. The system of claim 17, further comprising:
means for allowing a user to update said baseline model to reflect a new design for said software system.
